(19) United States
(12) Patent Application Publication
(10) Pub. No.: US 2017/0374249 A1
(43) Pub. Date: Dec. 28, 2017

(54) IMAGING DEVICE WITH REFLECTIVE OPTICAL ELEMENT

(71) Applicant: Microsoft Technology Licensing, LLC, Redmond, WA (US)

(72) Inventor: Ari Kimari, Pirkkala (FI)

(73) Assignee: Microsoft Technology Licensing, LLC, Redmond, WA (US)

(21) Appl. No.: 15/191,007

(22) Filed: Jun. 23, 2016

(51) Int. Cl. H04N 5/225; G02B 26/00; G02B 13/00; G02B 5/09; H04N 9/04; G02B 5/04

(52) U.S. Cl. CPC H04N 5/2254; H04N 9/045; G02B 5/04; G02B 13/0065; G02B 5/09; G02B 26/008

(57) ABSTRACT

Examples are disclosed that relate to an imaging device. One example provides an imaging device comprising a reflective optical element, a sensor system configured to receive light reflected by the reflective optical element, and a color filter arranged upstream of the reflective optical element, the color filter comprising two or more filter sections each having a different wavelength response. The reflective optical element and the sensor system form a fixed assembly, with the fixed assembly and the color filter being movable relative to one another such that light received at a portion of the sensor system via the reflective optical element is differently filtered based on a relative position between the color filter and the fixed assembly.

### BACKGROUND

Mobile devices frequently include an imaging device such as a camera. To provide a camera with desired optical characteristics, a minimum thickness may be imposed on the optical stack of the camera. Thin mobile device form factors are also typically desired, however, which may result in a tradeoff between optical performance and device size.

### BRIEF DESCRIPTION OF THE DRAWINGS

FIGS. 1A and 1B show an example mobile device including an imaging device.

FIG. 2 shows an example imaging device.

FIG. 3 shows an example reflective optical element that may form part of an imaging device.

FIG. 4 shows an example color filter of the example imaging device of FIG. 2 in detail.

FIG. 5 schematically illustrates light propagation in the example imaging device of FIG. 2 as a function of time.

FIG. 6 shows a flowchart illustrating a method of forming a color image.

### DETAILED DESCRIPTION

As described above, mobile devices frequently include an imaging device such as a camera (or camera component). To provide a camera with desired optical characteristics, a minimum thickness may be imposed on the optical stack of the camera. Thin mobile device form factors are also typically desired, and this may force tradeoffs between optical performance and device size. More specifically, optical performance (e.g., resolution, field-of-view, spectral and spatial response) may be sacrificed to accommodate thin form factors, and/or device size may be sacrificed (e.g., greater thickness) to accommodate components that provider higher optical performance.

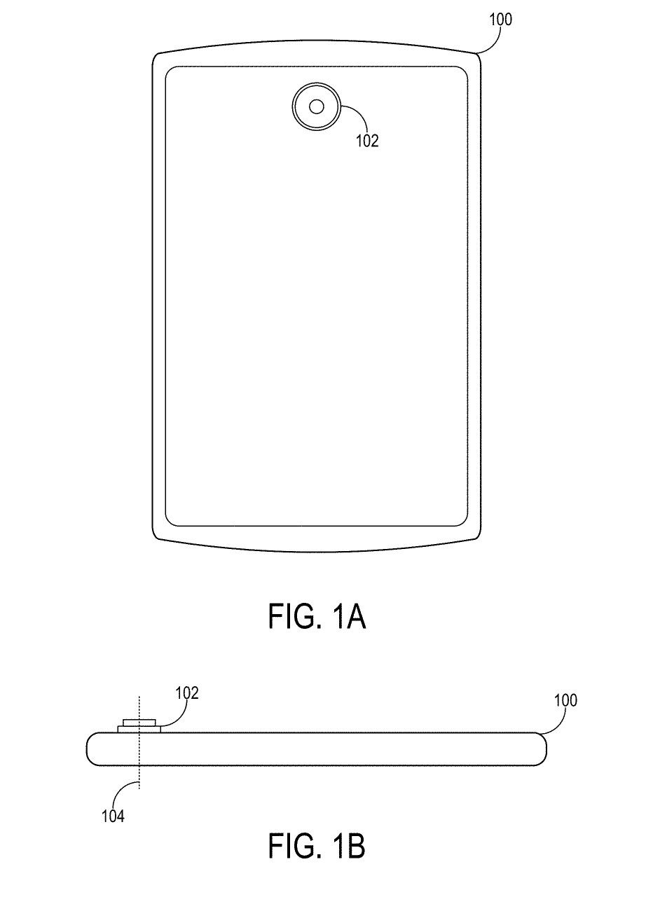

FIG. 1A shows an example mobile device 100 including an imaging device 102. As shown therein, imaging device 102 may be positioned on a rear surface of mobile device 100, opposite a front (e.g., user-facing) surface of a display. Imaging device 102 may be used to capture image data in the form of images and video, which may be displayed by mobile device 100 and/or otherwise stored, transmitted, provided as output, etc.

FIG. 1B shows a side view of mobile device 100. As shown therein, imaging device 102 protrudes out of the body of mobile device 100 in a direction 104—e.g., along an optical axis of the imaging device. The protrusion of imaging device 102 out of mobile device 100 may be the result of operating in the imaging device in an active state for collecting image data (e.g., extension of a lens), with the imaging device being at least partially retracted during an inactive state. Alternatively, imaging device 102 may protrude out of the body of mobile device 100 regardless of operating state. In either case, FIG. 1B illustrates how the protrusion/thickness of imaging device 102 may be at odds with mobile device 100 having a thin form factor. As indicated above, a desirable reduction in the degree of protrusion may come at the cost of lower performance.

Accordingly, examples are disclosed that relate to an imaging device comprising a reflective optical element, a sensor system, and a color filter arranged upstream of the reflective optical element. As described in further detail below, the sensor system may be configured to receive light reflected from the reflective optical element. The color filter may include two or more filter sections each having a different, wavelength response. The reflective optical element and the sensor system may form a fixed assembly movable relative to the color filter such that light received at a portion of the sensor system via the reflective optical element is differently filtered based on a relative position between the color filter and the fixed assembly.

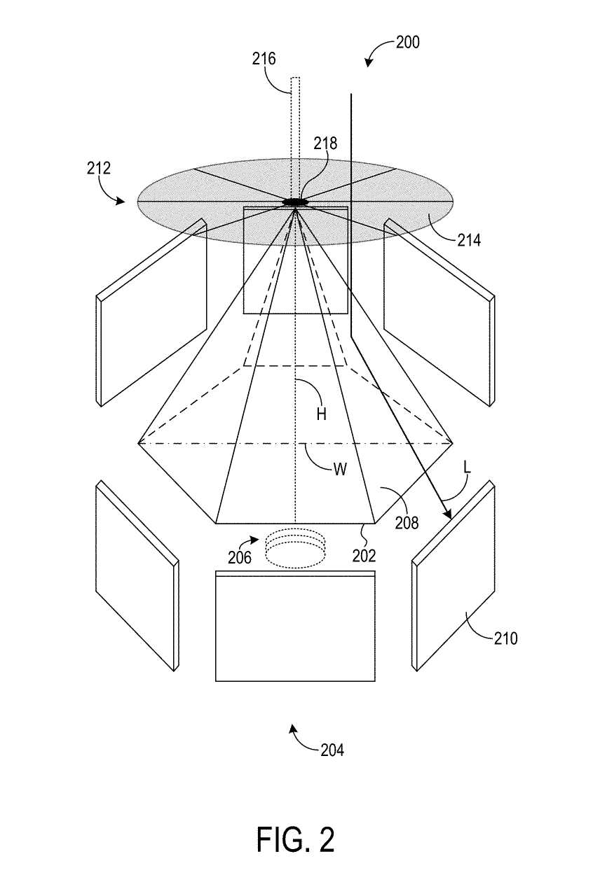

FIG. 2 shows an example imaging device 200. Imaging device 200 includes a reflective optical element (ROE) 202 configured to reflect inbound light L toward a sensor system 204. Sensor system 204 may receive reflected light L and produce image output based on the received light (e.g., via photosensitive surface(s) and other sensing elements). The image output may be processed and provided to a display device for visual perception by users, for example. Imaging device 200 may facilitate the implementation of low-thickness imaging devices, as a height H of ROE 202 may be reduced while retaining the optical functionality of the ROE by increasing a width W of the ROE. Further, optical elements (e.g., lenses, diffusers, polarizers) that might otherwise be placed upstream of ROE 202 and thus contribute to the thickness of imaging device 200, may instead be placed between the ROE and sensor system 204. As an example, FIG. 2 shows the potential inclusion of a lens system 206 in an optical path between ROE 202 and sensor system 204. In this way, the thickness (i.e., height along the direction of the inbound light) of imaging device 200 may be minimized when implemented in a device housing. Imaging device 200 may thus support thin device form factors and/or reduce or minimize the need to have imaging mechanisms protrude out of the device body. Imaging device 200 may be implemented in a mobile device (e.g., smartphone) at any suitable location or in any other suitable device (e.g., laptop or tablet computing device, display device).

As shown in FIG. 2, ROE 202 may be a pyramidal ROE comprising six faces. Each face may be configured to reflect light L toward a respective sensing element of sensor system 204. As a particular example, FIG. 2 shows the reflection of light L from a face 208 of ROE 202 toward a sensing element 210 of sensor system 204. Sensor system 204 may thus include a number (e.g., six) of sensing elements 210 that is equal to the number (e.g., six) of faces 208 of ROE 202. By situating a number of sensing elements 210 around ROE 202 in this manner, the ROE may outwardly reflect, for each sensing element, and to that sensing element, a portion of light coming into imaging device 200. A unique association between the location of light reception in imaging device 200 and the location of light sensing may thus be achieved.

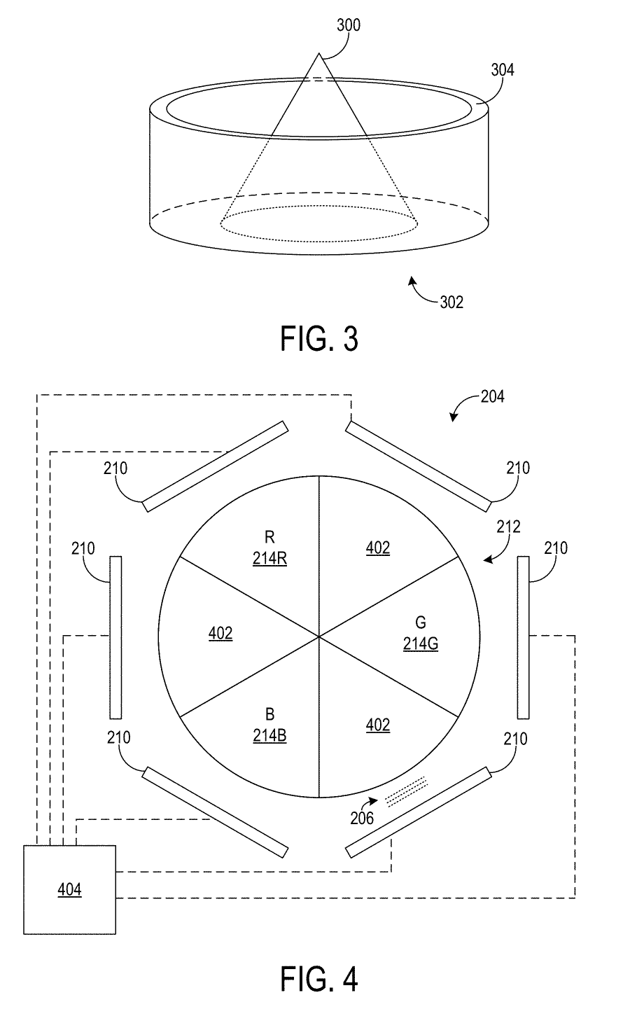

Other configurations of ROE 202 are contemplated. For example, ROE 202 may include any suitable number of faces 208, which in some examples may be equal to the number of sensing elements 210 and/or to a number of sections of a color filter described below. In other examples, ROE 202 may exhibit geometries other than the pyramidal geometry shown in FIG. 2. Turning briefly to FIG. 3, an ROE 300 is shown, which assumes a conical form. ROE 300 may be configured to reflect inbound light toward a sensor system 302 comprising a contiguous ring-shaped sensing element 304. The contiguous ring-shaped geometry of sensing element 304 may accommodate the conical geometry of ROE 300 such that light reflected at substantially any point on the surface of the ROE can be captured by a portion of the sensing element. However, implementations are possible in which one or more discrete sensing elements (e.g., elements 210 of FIG. 2) are used to sense light reflected from ROE 300, and in which sensing element. 304 is used to sense light reflected from ROE 202. To enable the reflection of light (e.g., and minimize transmission and/or absorption), ROEs 202 and 300 may include any suitable materials (e.g., glass), and in some examples may include a reflective coating.

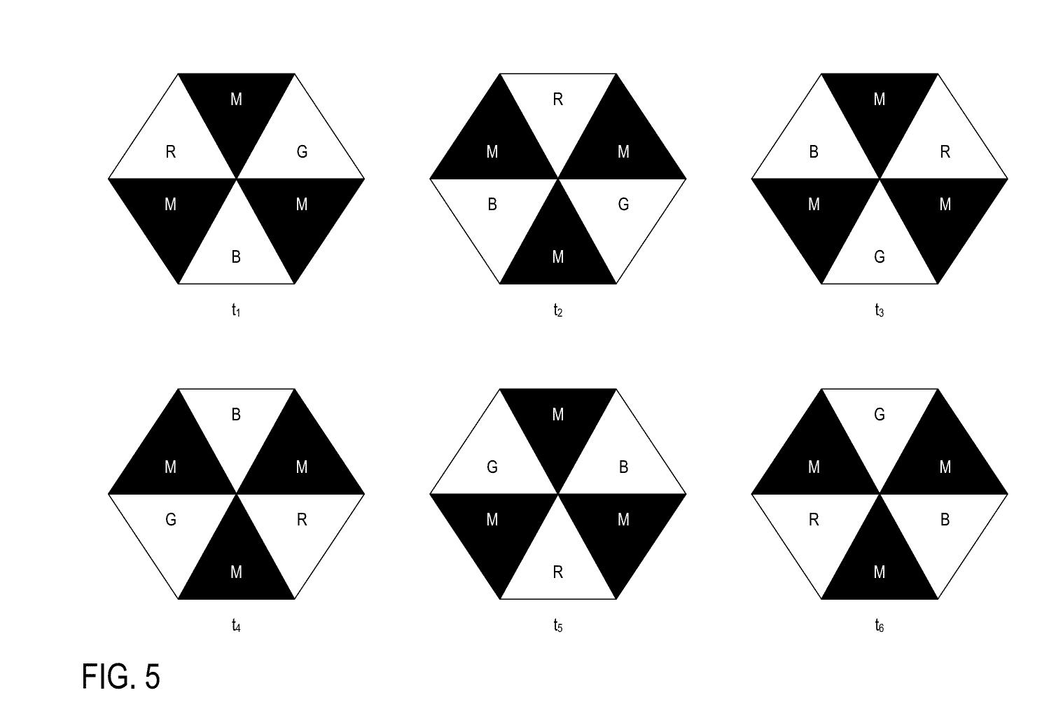

Returning to FIG. 2, ROE 202 and sensor system 204 form a fixed assembly such that the ROE and sensor system do not move (e.g., translate, rotate) with respect to each other. However, the fixed assembly is may be movable relative to a color filter 212 arranged upstream of ROE 202. Color filter 212 may include various sections including two or more filter sections (e.g., filter section 214) each having a different wavelength response. By imparting relative motion to the fixed assembly and color filter 212, light L received at a portion of sensor system 204 via ROE 202 may be differently filtered based on a relative position between the fixed assembly and color filter. For example, the portion of light L received by a given sensing element 210 may be filtered by filter section 214 of color filter 212 at a first relative position and filtered by a different filter section having a different wavelength response at a second relative position. FIG. 5 illustrates the reception of differently filtered light at different relative positions at ROE 202 and sensor system 204.

Color filter 212 may be configured for motion to enable the relative movement between the color filter and the fixed assembly. In some examples, color filter 212 may be movable via rotation. To this end, FIG. 2 shows the potential use of an actuator arm 216 coupled to color filter 212 and configured to impart rotational motion to the color filter. Actuator arm 216 may be driven by any suitable actuator, such as a motor. By arranging a number of filter sections about a central portion 218 of color filter 212 and configuring the color filter for rotation, the color filter may cyclically change the filtering applied to light received at each sensing element 210 of sensor system 204 according to the rotational orientation of the color filter. Rotation of color filter 212 may be continuous or variable, and in some examples may include periods of non-rotation to enable light collection. Implementations are possible, however, in which the fixed assembly is configured for motion to enable relative movement between the fixed assembly and color filter 212. In this example, ROE 202 and sensor system 204 may be coupled together via a suitable linkage or fixing method not shown in FIG. 2, where the linkage may in turn be coupled to actuator arm 216. Color filter 212 may be configured to remain stationary in this case. For implementations in which the fixed assembly is rotated, ROE 202 alternatively may be implemented as a rotating mirror (e.g., a reflective single surface).

Turning now to FIG. 4, color filter 212 is shown in greater detail. In the example depicted therein, color filter 212 includes three filter sections 214: a red filter section 214R, a green filter section 214G, and a blue filter section 214B, respectively configured to transmit visible wavelengths in the red, green, and blue spectral ranges. Color filter 212 may be configured with filter sections 214 to enable sensing of substantially the visible spectrum, but alternatively or additionally may include filter sections corresponding to any suitable spectral ranges (e.g., infrared, ultraviolet). In some examples, color filter 212 may include filter sections of substantially the same wavelength response (e.g., two or more green filter sections). Color filter 212 may further include at least one mask section that substantially inhibits the transmission of light. In the particular example illustrated in FIG. 4, color filter 212 includes three mask sections 402 interleaved between filter sections 214. By substantially inhibiting the transmission light, mask sections 402 may provide a shuttering function to sensor system 204, which is also depicted in FIG. 2. In this way, the reception at a sensing element 210 of light filtered by one filter section 214 can be isolated from the reception at the sensing element of light filtered by another filter section 214 to provide high signal integrity.

FIG. 4 also shows a controller 404 operatively coupled to sensor system 204. For a given portion of sensor system 204, controller 404 may be configured to receive outputs associated with filtering by each filter section 214 and combine those outputs into a color image. As an example, controller 404 may receive from a sensing element 210 outputs respectively associated with light filtration through red, blue, and green filter sections 214R. 214G, and 214B. With these outputs received, controller 404 may then combine the outputs to produce an RGB color image. In some examples, controller 404 may discard output from sensing elements 210 during periods in which light transmission to the sensing elements is substantially inhibited by mask sections 402.

FIG. 5 schematically illustrates light propagation in imaging device 200 of FIG. 2 as a function of time, with references to FIGS. 1-4 made throughout the description of FIG. 5. Specifically, the type of light received at each face 208 of ROE 202 for each time step in a color image generation cycle is shown—e.g., aspects illustrated include which filter section 214 light is filtered through for each face, or whether light is substantially inhibited by a mask section 402 for that face. While shown as discrete time steps in the color image generation cycle, rotation in the cycle may be continuous or variable as described above. At the end of the cycle—e.g., once each portion (e.g., sensing element 210) of sensor system 204 has collected light filtered through each filter section 214—controller 404 may produce a color image by combining the output from each portion associated with each type of light filtration.

In the example depicted in FIG. 5, each face 208 receives light filtered through each filter section 214 and has light substantially inhibited by each mask section 402. Likewise, each portion (e.g., sensing element 210) of sensor system 204 receives light filtered through each filter section 214 and has light substantially inhibited by each mask section 402. For a particular face 208, light is filtered through red filter section 214R (R) at t₁, substantially inhibited by a mask section 402 (M) at t₂, filtered through blue filter section 214B (B) at t₃, substantially inhibited by a mask section 402 (M) at t₄, filtered through green filter section 214G (G) at t₅, and then substantially inhibited by a mask section 402 (M) at t₆.

While examples described herein provide a total number of filter and mask sections (e.g., sections 214 and 402) equal to the number of ROE reflective surfaces (e.g., faces 208) and to the number of sensing element portions (e.g., sensing elements 210), implementations are contemplated in which one or more of the total number of filter and mask sections, number of ROE reflective surfaces, and number of sensing element portions are not equal. Moreover, the types of relative movement between color filter 212 and the fixed assembly (e.g., including ROE 202 and sensor system 204) described above are provided as examples. Any suitable relative movement may be applied to effect the approaches described herein.

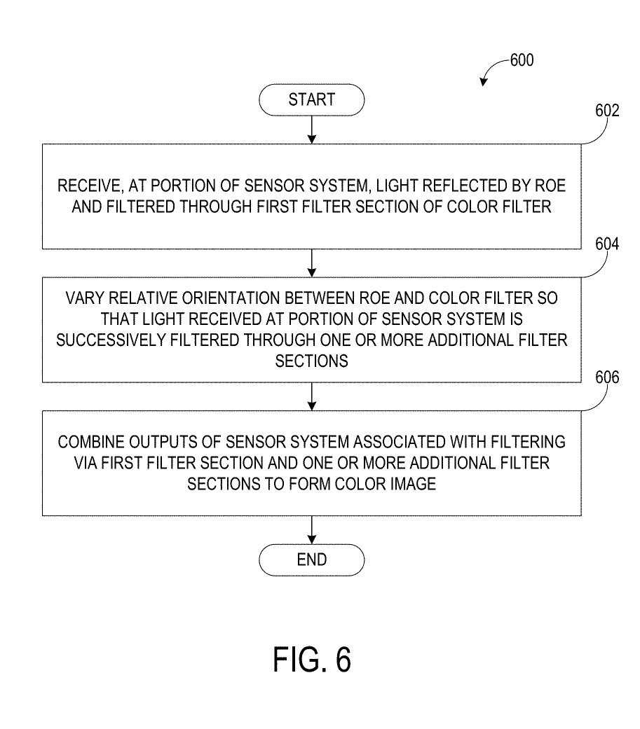

FIG. 6 shows a flowchart illustrating a method 600 of forming a color image. Method 600 may be implemented on controller 404 of FIG. 4, for example.

At 602, method 600 includes receiving, at a portion of a sensor system, light reflected by an ROE and filtered through a first filter section of a color filter having a plurality of filter sections, each of the filter sections having a different wavelength response. The sensor system may be sensor system 204 of FIG. 2 or sensor system 302 of FIG. 3. The portion of the sensor system may be one or more sensing elements 210 of sensor system 204, or ring-shaped sensing element 304 of FIG. 3. The ROE may be ROE 202 or 300 of FIGS. 2 and 3, respectively. The first filter section may be one of filter sections 214R, 214G, and 214B of color filter 212 of FIG. 2.

At 604, method 600 includes varying a relative orientation between the ROE and the color filter so that light received at the portion of the sensor system via reflection from the ROE is filtered, successively, through one or more additional filter sections of the plurality of filter sections. Varying the relative orientation may include rotating the color filter or rotating a fixed assembly comprising the ROE and the sensor system. Actuator arm 216 of FIG. 2 may be used to rotate the color filter, for example. The relative orientation may be varied so that light is filtered through one or more of filter sections 214R, 214G, and 214B of color filter 212 of FIG. 2, and in some examples all of the filter sections. The filter section through which light is filtered and received by each portion (e.g., sensing element) may be varied for each variation of the relative orientation. The ROE may be a pyramidal ROE, and the relative orientation between the ROE and the color filter may be varied so that, for each variation of the relative orientation, light is reflected by a different face of the pyramidal reflective optical element. The relative orientation may be varied so that filtering light through each filter section is interrupted by substantially inhibiting light by one of a plurality of mask sections (e.g., mask sections 402 of FIG. 4).

At 606, method 600 includes combining outputs of the sensor system associated with filtering via the first filter section and the one or more additional filter sections to form a color image. Controller 404 may combine outputs from one or more sensing elements 210 of sensor system 204 of FIG. 2 or from ring-shaped sensing element 304 of sensor system 302 of FIG. 3. In some examples, combining outputs may include combining, for each portion of the sensor system, outputs associated with each filter section of the color filter. For example, for each sensing element 210 of sensor system 204 of FIG. 2, outputs associated with each filter sections 214R, 214G, and 214B may be combined. In this example, the R, G, and B outputs may then be combined with the R, G, and B outputs for each of the other sensing elements 210 to form a color image.

The following paragraphs provide additional support for the claims of the subject application. One aspect provides an imaging device comprising a reflective optical element, a sensor system configured to receive light reflected by the reflective optical element, and a color filter arranged upstream of the reflective optical element, the color filter comprising two or more filter sections each having a different wavelength response, where the reflective optical element and the sensor system form a fixed assembly, the fixed assembly and the color filter being movable relative to one another such that light received at a portion of the sensor system via the reflective optical element is differently filtered based on a relative position between the color filter and the fixed assembly. In this aspect, the reflective optical element alternatively or additionally may be conical. In this aspect, the reflective optical element alternatively or additionally may be pyramidal. In this aspect, the color filter alternatively or additionally may include red, green, and blue filter sections. In this aspect, the color filter alternatively or additionally may include at least one mask section that substantially inhibits the transmission of light. In this aspect, the fixed assembly and the color filter alternatively or additionally may be movable relative to one another via rotation. In this aspect, the sensor system alternatively or additionally may include a number of sensing elements situated around the reflective optical element, the reflective optical element being configured so that for each of the number of sensing elements, a portion of light coming in to the imaging device is reflected outward by the reflective optical element to that sensing element, and the color filter alternatively or additionally may have a number of filter sections arranged about a central portion of the color filter, the color filter being configured to rotate so as to cyclically change the filtering applied to light being received at each of the number of sensing elements. In this aspect, the imaging device alternatively or additionally may comprise a controller configured to receive, from the portion of the sensor system, outputs associated with filtering by each of the filter sections, and combine those outputs into a color image. In this aspect, the color filter alternatively or additionally may include red, green, and blue sections, and three mask sections interleaved between those sections, the sensor system alternatively or additionally may include six sensing elements, and the reflective optical element alternatively or additionally may be a pyramidal reflective optical element including six faces, each being configured to reflect light toward a respective sensing element of the sensor system. In this aspect, the sensor system alternatively or additionally may include a contiguous ring-shaped sensing element.

Another aspect provides a method of forming a color image comprising receiving, at a portion of a sensor system, light reflected by a reflective optical element and filtered through a first filter section of a color filter having a plurality of filter sections, each of the filter sections having a different wavelength response, varying a relative orientation between the reflective optical element and the color filter so that light received at the portion of the sensor system via reflection from the reflective optical element is filtered, successively, through one or more additional filter sections of the plurality of filter sections, and combining outputs of the sensor system associated with filtering via the first filter section and the one or more additional filter sections to form a color image. In this aspect, varying the relative orientation between the reflective optical element and the color filter alternatively or additionally may include rotating the color filter. In this aspect, the first filter section alternatively or additionally may be a red filter section, the plurality of filter sections further including a green and a blue filter section, the relative orientation between the reflective optical element and the color filter alternatively or additionally may be varied so that light received at the portion of the sensor system is successively filtered through the green and blue filter sections, and combining the outputs of the sensor system alternatively or additionally may include combining outputs respectively associated with filtering via the red, green, and blue filter sections to form the color image. In this aspect, the plurality of filter sections alternatively or additionally may be interleaved by a plurality of mask sections between the filter sections, and the relative orientation between the reflective optical element and the color filter alternatively or additionally may be varied so that filtering light through each filter section is interrupted by substantially inhibiting light with one of the plurality of mask sections. In this aspect, the reflective optical element alternatively or additionally may be a pyramidal reflective optical element, and the relative orientation between the reflective optical element and the color filter alternatively or additionally may be varied so that, for each variation of the relative orientation, light filtered through a given one of the plurality of filter sections is reflected by a different face of the pyramidal reflective optical element. In this aspect, the sensor system alternatively or additionally may include a plurality of sensing elements, and the filter section through which light is filtered and received by each sensing element alternatively or additionally may be varied for each variation of the relative orientation. In this aspect, the reflective optical element and the sensor system alternatively or additionally may form a fixed assembly, and varying the relative orientation between the reflective optical element and the color filter alternatively or additionally may include rotating the fixed assembly.

Another aspect provides an imaging device comprising a reflective optical element, a sensor system comprising three sensing elements, the sensor system configured to receive light reflected by the reflective optical element, and a rotary color filter arranged upstream of the reflective optical element, the rotary color filter comprising red, green, and blue filter sections each having a different wavelength response, where the reflective optical element and the sensor system form a fixed assembly, the rotary color filter being rotatable relative to the fixed assembly such that light received at a portion of the sensor system via the reflective optical element is differently filtered based on a rotational orientation of the rotary color filter. In this aspect, the reflective optical element alternatively or additionally may be a pyramidal reflective optical element comprising three faces, each face configured to reflect light toward a respective one of the three sensing elements. In this aspect, the rotary color filter alternatively or additionally may include three mask sections interleaved between the red, green, and blue filter sections, the three mask sections configured to substantially inhibit the transmission of light.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. An imaging device, comprising:
a reflective optical element;
a sensor system configured to receive light reflected by the reflective optical element; and
a color filter arranged upstream of the reflective optical element, the color filter comprising two or more filter sections each arranged about a central portion of the color filter and having a different wavelength response;
where the reflective optical element and the sensor system form a fixed assembly, the fixed assembly and the color filter being movable relative to one another such that light received at a portion of the sensor system via the reflective optical element is differently filtered based on a relative position between the color filter and the fixed assembly, and where such different filtering varies repeatedly at the portion of the sensor system as the two or more filter sections move relative to the fixed assembly, the sensor system receiving light filtered by the two or more filter sections at the relative position.

2. The imaging device of claim 1, where the reflective optical element is conical.

3. The imaging device of claim 1, where the reflective optical element is pyramidal.

4. The imaging device of claim 1, where the color filter includes red, green, and blue filter sections.

5. The imaging device of claim 1, where the color filter includes at least one mask section that substantially inhibits the transmission of light.

6. The imaging device of claim 1, where the fixed assembly and the color filter are movable relative to one another via rotation.

7. The imaging device of claim 1,
where the sensor system includes a number of sensing elements situated around the reflective optical element, the reflective optical element being configured so that for each of the number of sensing elements, a portion of light coming in to the imaging device is reflected outward by the reflective optical element to that sensing element; and
where the color filter is configured to rotate so as to cyclically change the filtering applied to light being received at each of the number of sensing elements.

8. The imaging device of claim 1, further comprising a controller configured to receive, from the portion of the sensor system, outputs associated with filtering by each of the filter sections, and combine those outputs into a color image.

9. The imaging device of claim 1, where
the color filter includes red, green, and blue sections, and three mask sections interleaved between those sections;
the sensor system includes six sensing elements; and
the reflective optical element is a pyramidal reflective optical element including six faces, each being configured to reflect light toward a respective sensing element of the sensor system.

10. The imaging device of claim 1, where the sensor system includes a contiguous ring-shaped sensing element.

11. A method of forming a color image, comprising:
receiving, at a portion of a sensor system, light reflected by a reflective optical element and filtered through a first filter section of a color filter having a plurality of filter sections arranged about a central portion of the color filter, each of the filter sections having a different wavelength response;
varying a relative orientation between the reflective optical element and the color filter so that light received at the portion of the sensor system via reflection from the reflective optical element is filtered, successively, through one or more additional filter sections of the plurality of filter sections, the sensor system receiving light filtered by two or more of the plurality of filter sections at the relative orientation; and
combining outputs of the sensor system associated with filtering via the first filter section and the one or more additional filter sections to form a color image.

12. The method of claim 11, where varying the relative orientation between the reflective optical element and the color filter includes rotating the color filter.

13. The method of claim 11, where the first filter section is a red filter section, the plurality of filter sections further including a green and a blue filter section;
where the relative orientation between the reflective optical element and the color filter is varied so that light received at the portion of the sensor system is successively filtered through the green and blue filter sections; and
where combining the outputs of the sensor system includes combining outputs respectively associated with filtering via the red, green, and blue filter sections to form the color image.

14. The method of claim 11, where the plurality of filter sections are interleaved by a plurality of mask sections between the filter sections; and
where the relative orientation between the reflective optical element and the color filter is varied so that filtering light through each filter section is interrupted by substantially inhibiting light with one of the plurality of mask sections.

15. The method of claim 11, where the reflective optical element is a pyramidal reflective optical element; and
where the relative orientation between the reflective optical element and the color filter is varied so that, for each variation of the relative orientation, light filtered through a given one of the plurality of filter sections is reflected by a different face of the pyramidal reflective optical element.

16. The method of claim 11, where the sensor system includes a plurality of sensing elements; and
where the filter section through which light is filtered and received by each sensing element is varied for each variation of the relative orientation.

17. The method of claim 11, where the reflective optical element and the sensor system form a fixed assembly; and
where varying the relative orientation between the reflective optical element and the color filter includes rotating the fixed assembly.

18. An imaging device, comprising:
a reflective optical element;
a sensor system comprising three sensing elements, the sensor system configured to receive light reflected by the reflective optical element; and
a rotary color filter arranged upstream of the reflective optical element, the rotary color filter comprising red, green, and blue filter sections arranged about a central portion of the rotary color filter and each having a different wavelength response;
where the reflective optical element and the sensor system form a fixed assembly, the rotary color filter being rotatable relative to the fixed assembly such that light received at a portion of the sensor system via the reflective optical element is differently filtered based on a rotational orientation of the rotary color filter, and where such different filtering varies repeatedly at the portion of the sensor system as the blue filter sections move relative to the fixed assembly, the sensor system receiving light filtered by two or more of the blue filter sections at the rotational orientation.

19. The imaging device of claim 18, where the reflective optical element is a pyramidal reflective optical element comprising three faces, each face configured to reflect light toward a respective one of the three sensing elements.

20. The imaging device of claim 18, where the rotary color filter further includes three mask sections interleaved between the red, green, and blue filter sections, the three mask sections configured to substantially inhibit the transmission of light.
